(19) United States
(12) Patent Application Publication
(10) Pub. No.: US 2002/0099720 A1
(43) Pub. Date: Jul. 25, 2002

(54) Directory search using additional information and resources

(76) Inventor: Pradeep Bansal, Dayton, NJ (US)

Correspondence Address: BANNER & WITCOFF, 1001 G STREET N W, SUITE 1100, WASHINGTON, DC, 20001, US

(21) Appl. No.: 09/766,655

(22) Filed: Jan. 23, 2001

(51) Int. Cl. G06F 17/00; G06F 15/16

(52) U.S. Cl. 707/104.1; 709/203

(57) ABSTRACT

A method and system for performing improved directory assistance searches is provided. A first embodiment uses genealogical information to narrow search results to include only those listings related the genealogical relative. A second embodiment maintains old listings and links the old listings to new listings as individuals and organizations move from one location and/or telephone number to another. Users searching for target listings can follow the links to determine whether information is current. In a third embodiment, an accuracy indicator is used to indicate the last date on which the listing data was likely known to be accurate. In a fourth embodiment, a modified world wide web search is performed to supplement the directory assistance search. A selection screen is used to allow a user to select the method(s) to be used to perform the search.

### BACKGROUND OF THE INVENTION

The present invention relates to querying directory information. More specifically, the present invention is an improved method and system for providing a requested directory listing corresponding to user-provided information.

Traditionally, when a telephone caller (user) needs to determine the telephone number of a target individual or organization, the caller contacts directory assistance, also known as directory inquiries, provides the target entity's name and city of residence, and receives the telephone number for the entity in the provided city.

However, many problems are encountered in this system. For instance, if there is no entity located in the provided city, or if the caller provides the wrong city, the entity will not be found. Also, if there are more than one entity with the same name (e.g. John Smith) in a given city, multiple phone numbers will be found (multiple hits). In such a scenario, the caller most likely does not know which phone number is correct for the specific entity (i.e., which of the many John Smiths) the caller is trying to call. Another typical problem is that the caller often misspells the name of the entity, and thus no telephone number is found (garbage in-garbage out). It is also possible that the information in a directory assistance provider's database is no longer correct or changed periodically (e.g., bad information, the entity has moved, the entity maintains two homes for half the year each).

As systems improved, directory assistance has become able to provide callers with telephone number information for more than just a single city. That is, the caller can request that more than just a single city be searched for an entity's telephone number. For example, a caller may be trying to find out the telephone number of ‘Michael Jones,” but the caller does not know the exact city Michael Jones lives in. The caller does, however, know that Michael Jones lives in the Washington, D.C. metropolitan area. Directory assistance can now search a predetermined entire area for an entity's telephone listing information, instead of merely one city. It is also possible to search the entire United States.

While this is an improvement, many problems still remain, such as the problem of receiving multiple hits, garbage in-garbage out, and bad and untimely information.

With the advent of the Internet, telephone callers can go to various websites, such as AT&T's website powered by ANYWHO at www.att.com/directories, and perform a search for telephone number information anywhere in the U.S. While this allows callers to perform searches without being required to contact directory assistance, it does not improve the accuracy of the results with respect to the problems described above. Thus, an improved directory search is required that takes into account problems associated with multiple hits, garbage in-garbage out, and bad or untimely information results.

### SUMMARY OF THE INVENTION

In a first embodiment there is a system for providing a directory listing based on genealogical information. A database includes a plurality of records, where each record contains directory listing information for a target entity. A server computer is adapted to receive query information, including genealogical information, from a user; to search the database or a remote database for the query information; and to present a query result to the user.

In a second embodiment there is a system for providing a directory listing including history and recency information. There is a database including records containing directory listing information for an entity. Records are linked together when the records contain chronologically different information corresponding to a same entity. There is a server computer adapted to receive query information from a user; to search the database for listings corresponding to the query information; and to provide a query result to the user responsive to the chronological data and the correct date. The query result includes at least one indicator for each listing that is linked to other listings in the database.

In one variation, the server computer is adapted to recursively present the linked listing to the user when the user activates the indictor. The linked listing is presented with at least one indicator when the linked listing is linked to at least one other listing in the database.

In another variation the server computer is adapted to present a first indicator when the listing is linked to a chronologically older listing in the database, and to present a second indicator when the listing is linked to a chronologically newer listing in the database.

In a third embodiment there is a system for providing a directory listing including accuracy information. There is a database comprising a plurality of records, each record containing directory listing information and an accuracy data field corresponding to an entity. There is a server computer adapted to receive query information, corresponding to a user-sought entity, from a user; to search the database for database listings corresponding to the query information; and to present the query results to the user. The query results include the contents of the accuracy field for each directory listing presented.

In a fourth embodiment there is a system for providing a directory listing including results from an Internet search. There is a database containing a plurality of records. Each record contains directory listing information for an entity. There is a server computer adapted to receive query information from a user. The query information includes one of a telephone number and an email address. The server computer also searches the database for the query information, searches the Internet for the query information, and provides the query results from both searches to the user.

In one variation, when the query information includes a telephone number, the server computer defines an area code portion, an exchange portion, and a number portion corresponding to the telephone number. The server computer searches the Internet by searching for telephone numbers on web pages where the telephone numbers on the web pages include one or more of the area code portion, the exchange portion, and the number portion, regardless of a presentation format on the web pages.

In another variation, when the query information includes an email address, the server computer defines a username portion and a domain name portion corresponding to the email address. The server computer searches the Internet by searching for email addresses on web pages where the email address on the web page includes at least the username portion and the domain name portion of the user-entered email address.

### BRIEF DESCRIPTION OF THE DRAWINGS

The invention will be described in detail in the following description of preferred embodiments with reference to the following figures wherein:

FIG. 1 is a flowchart of a first embodiment of the invention.

FIG. 2 is a graphical representation of a target information input screen.

FIG. 3 is a graphical representation of a genealogical input screen.

FIG. 4 is another flowchart of a first embodiment of the invention.

FIG. 5 is a flowchart of a second embodiment of the invention.

FIG. 6 is a graphical representation of output provided by the invention.

FIG. 7 is a graphical representation of output provided by another embodiment of the invention.

FIG. 8 is a relational diagram of an embodiment of the invention.

### DETAILED DESCRIPTION OF PREFERRED EMBODIMENTS

When a person (user) needs to call another individual or organization, directory assistance is often contacted in order to locate the necessary telephone number. Directory assistance can be obtained over the telephone, via 411, entry of an area code and 555-1212, and the like, or accessed through an Internet website such as AT&T's AnyWho.com. For instance, when a user is looking for a local or national listing for John Smith, the user may dial 411 on their telephone to ask directory assistance, or access an Internet website, to obtain the telephone number. Generally, a search merely for ‘John Smith’ is likely to reveal several listings, as John Smith is a common name. The user traditionally has been left with the option of guessing which entry is the “right” one.

The present invention allows the user to query additional information and resources, in addition to name and address information, in order to more accurately locate the “correct” John Smith. The invention, generally, uses information in addition to name and address data to allow the user to refine or narrow a search. This additional information can also be used to select the correct listing when a search returns more than one listing in response to a user's request.

In a first embodiment of the invention, using genealogical information regarding a target entity as provided by a user, an improved directory search is performed. That is, a user can use genealogical information such as an intended target's, parents' and siblings' names to narrow a search for a target entity, and thus isolate the correct listing from the multiple listings, based on the genealogical information known to the user.

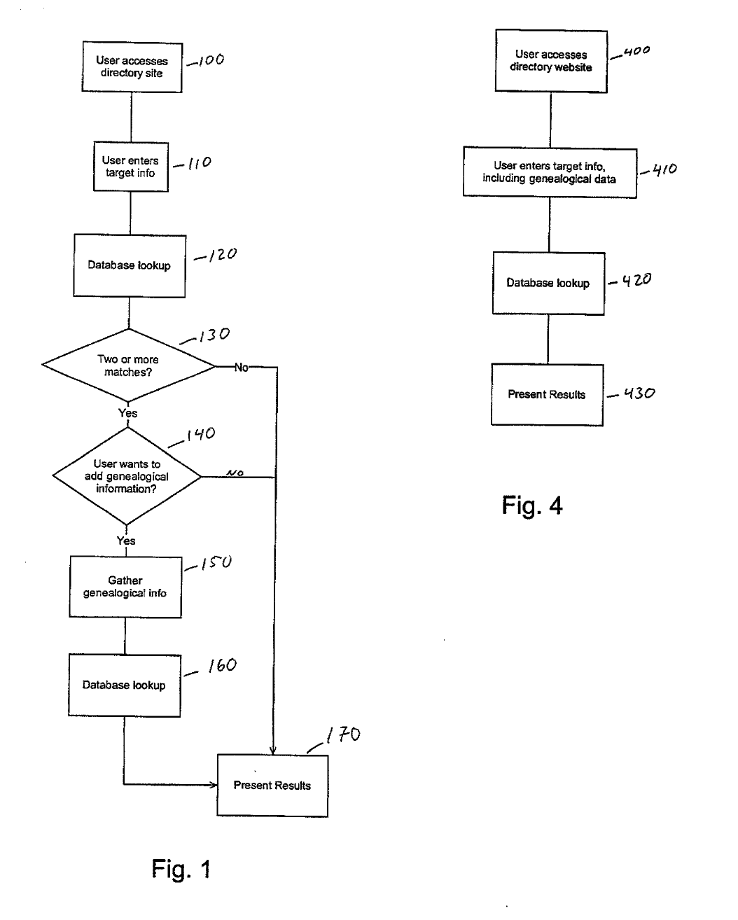

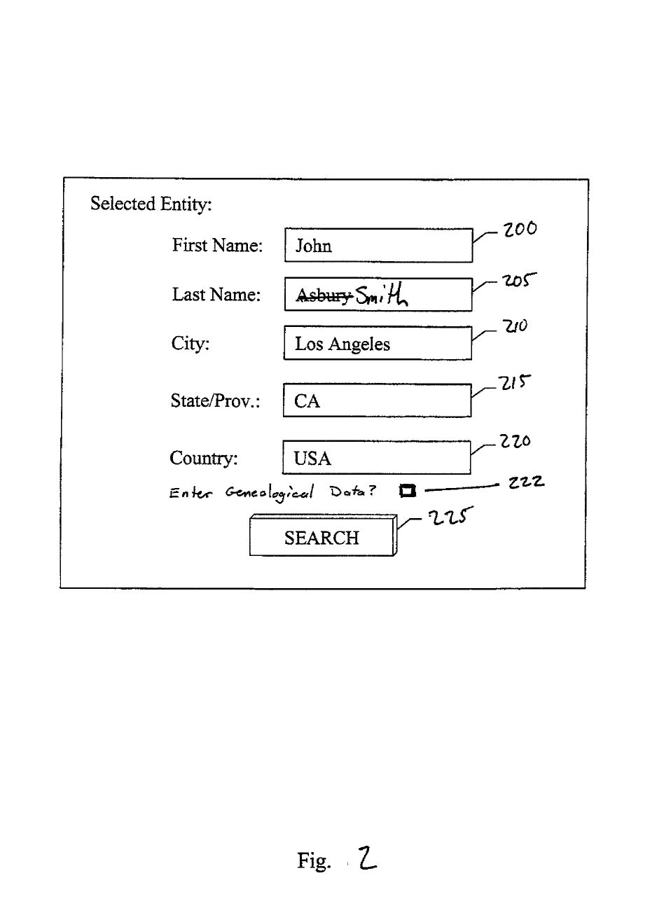

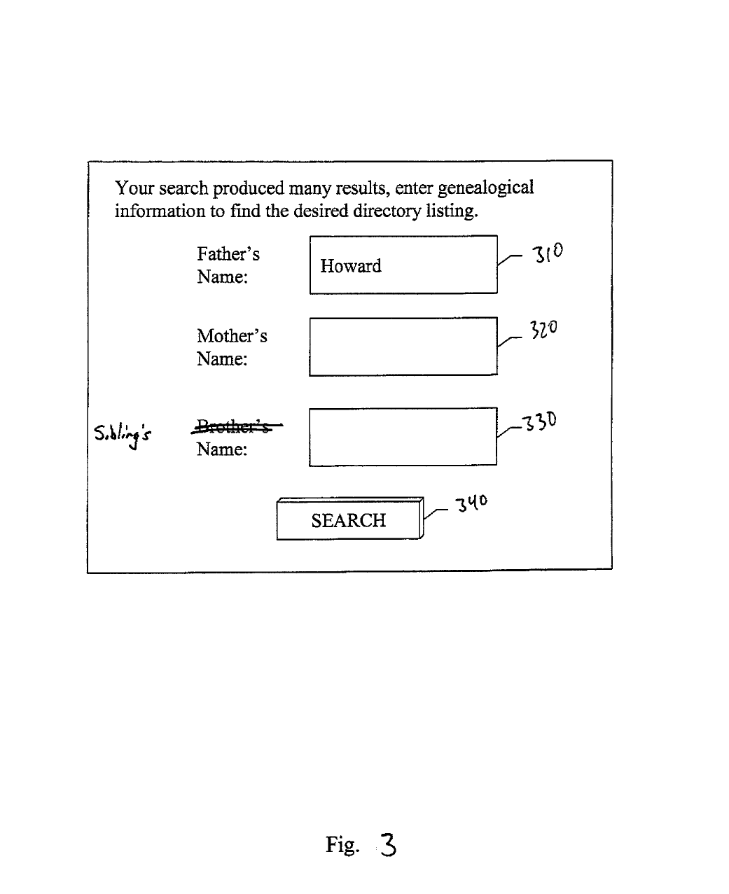

In one variation, with reference to FIGS. 1-3, a user accesses a website through which a directory assistance lookup can be performed, shown in step 100. The user enters the pertinent information regarding the target in step 110. This information may include the target's first name or initial 200, last name 205, city of residence 210, state or province of residence 215, country of residence 220. It is also possible to include other information such as the target's middle initial or address (not shown) for additional accuracy. When the user enters all the information which is to be included in the database query, the user initiates the query by clicking button 225. It should be understood that any user-actuated switch can be used, and button 225 is for example only.

The system performs the database query in step 120 according to known means. In step 130, the system determines whether there are multiple hits (i.e., at least two target listings match the criteria provided by the user). If the database query from step 120 does not return multiple hits as determined in step 130, the system proceeds directly to step 170, wherein the database query results are presented to the user.

If the system determines that multiple hits were found during the database query, the system prompts the user to input whether the user would like to attempt to narrow the search results based on genealogical data. This is performed in step 140. If the user does not want to narrow the search based on genealogical data, the system proceeds to step 170, wherein the database query results (including all multiple hits) are presented to the user.

If the user wants to attempt to narrow the search based on genealogical information pertaining to the intended target, the system gathers the genealogical information from the user regarding the target in step 150. The genealogical information may include parents' names (310, 320) and a sibling's name 330. When the user has entered the genealogical information that the user desires to include in the database query, the user initiates the query by clicking on button 340. The system then performs a second database query based on the genealogical information in step 160. Genealogical data may be searched using a website such as Ancestry.com or the Church of Jesus Christ of Latter Day Saints.

The results from the second database query are presented in step 170. The information presented in step 170 can include name, address, and telephone number (or any other information in the database) for both the target and the genealogical relative. This allows the user to look at the listings for all the potential targets, refine the search to include only those targets that are listed as being sons/daughters/siblings of the genealogical relative, and determine which target is the correct target based on the relation to one or more genealogical relatives. In the case where more than one target listing remains after refining the search, the user can select the correct target based on the address information provided for the target and/or genealogical relative, thereby improving the chances of finding the correct listing.

By way of example, a user may access a website at which a directory search can be performed, looking for a target individual named John Smith. If multiple hits are returned, the user can narrow the search based on genealogical information. The user may know that the John Smith being queried for is the son of Mike Smith. This genealogical information can be entered by the user if the search returns multiple hits (i.e. more than one John Smith) in order to narrow the search to return only those John Smiths that are sons of a Mike Smith.

In another variation, shown in FIG. 4, the user can enter the genealogical information pertaining to the target at the time the search is initiated. The user uses indicator checkbox 222 to communicate to the system that genealogical information is to be entered. Optionally (not shown), the system includes the genealogical information fields on the same screen as the target data fields.

By including genealogical information, the database query returns listings of those targets that are children (or siblings) of the user-inputted genealogical relative(s). Optionally, the system can also include target listings which have incomplete information, such that those portions of the listing that are presented do not contradict the information being sought by the user. In another variation, genealogical data is provided with the search results independent of any request by the user.

This embodiment of the invention allows a user to find a target even if the target has moved, provided the user knows the name and/or address of one of the target's relatives. While the system may return old information for the target being sought, the user can contact a relative of the target (using the genealogical and directory information provided by the database query), and get current contact information for the target.

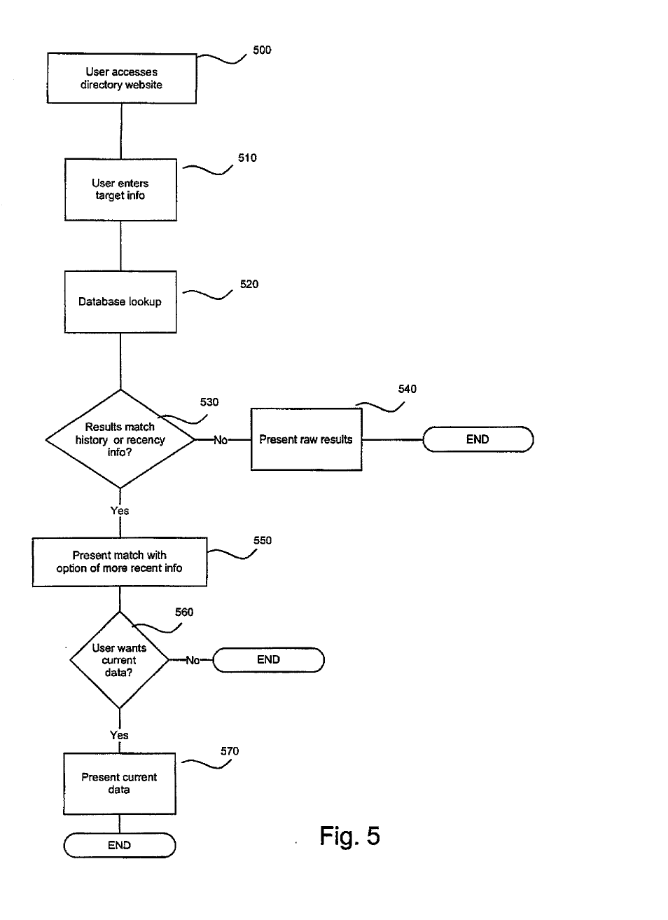

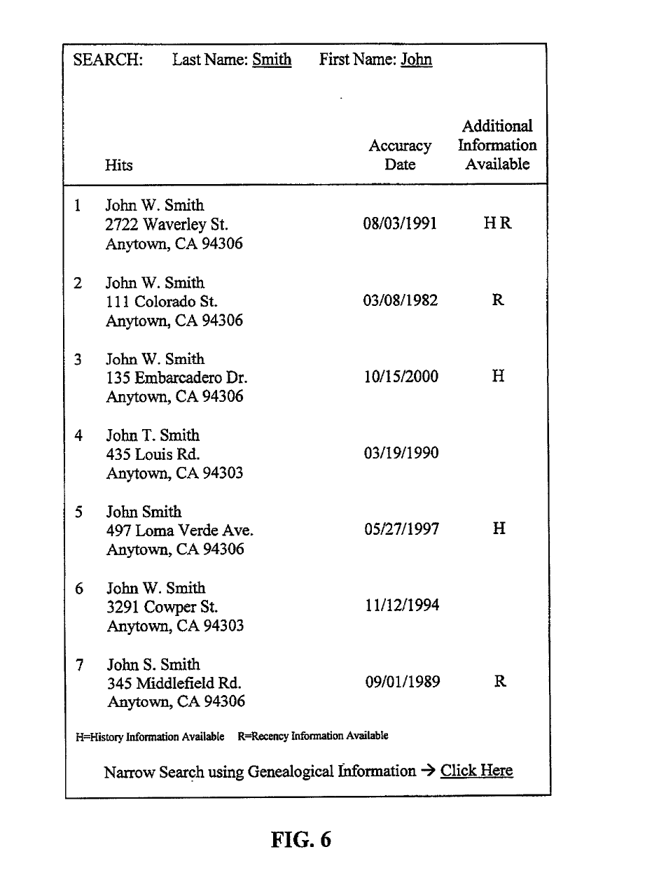

With additional reference to FIGS. 5-6, in a second embodiment of the invention, history and recency data are used to improve the directory search (database query). In this embodiment, history and recency information associated with each listing are maintained. That is, when an individual or organization moves, instead of deleting the old listing and replacing it with new information, the old listing is retained and linked to the new listing. History information is information regarding previous listings (data entries) linked to the current listing. Recency information is information regarding more recent listings linked to the current listing.

When a user searches for a target, old and new listings are presented as separate, distinct listings. There is an indicator (602, 604) next to each listing with which more recent information is associated (linked), history information is associated, or both. When the user recognizes an old listing and not a new one, the user can click on a recency information indicator 604 to view the newer listing, and retrieve the more recent information. If the user does not recognize any of the listings, but history data is available, the user can click on the history indicator 602 to search older records for one that the user recognizes.

A user begins by accessing a website through which a search can be performed, in step 500. The user enters pertinent information regarding the target in step 510. This information can include the target's first name or initial 200, last name 205, city of residence 210, state or province of residence 215, country of residence 220. It is also possible to include other information such as the target's address (not shown) for additional accuracy. When the user enters all the information which is to be included in the database query, the user initiates the query by clicking button 225.

Upon clicking button 225 (or other user-actuated switch), the database query is performed in step 520. The system determines, in step 530, whether there are any matching listings that include history or recency info. If no history or recency info is found, the matching listings are presented in step 540. If matching listings including history and/or recency info is found, the results are displayed (step 550) with an indicator (602, 604) to inform the user that more recent data and/or historical data is available for that listing. History data may also include periodic data (not shown), such as when an entity maintains two homes (e.g., summer home and winter cabin, etc.), residing in each one for a predetermined portion of the year.

If the user wants to view the history or recency info, as determined in step 560, the user may click on the indicator, which may be hyperlinked to a web page that provides the history (via indicator 602) or recency (via indicator 604) information, respectively, in step 570.

For instance, FIG. 6 shows results from a user search for John Smith. Multiple listings were returned by the database query because it is a common name. Because the specific John Smith that the user is searching for may have moved, the user might have old address and/or telephone information. Thus, because the user may not know the current information for the “correct” John Smith, the user may be unable to determine which of the several listings is the current information for the correct John Smith because the user only knows the correct John Smith's old information. In one variation, the user may click on the history indicator to search for an older listing which the user recognizes. Upon locating the older listing that the user recognizes, the user can determine the correct John Smith's current information by then clicking on the recency indicator associated with the listing until the present information is obtained. In FIG. 6, Hits 1-3 are linked via history and recency indicators. That is, Hit 2 is the oldest listing, with a recency indicator linking to Hit 1. Hit 1 has a history indicator linking to Hit 2, and a recency indicator linking to Hit 3. If the user recognizes the information associated with Hit 1 as the “correct” John Smith, the user can click on the recency indicator to see the current information. At which point, the user will be shown only Hit 3, and the user will now know the “correct” John Smith's current contact information.

In a third embodiment, an accuracy indicator 612 is used to improve the directory search (database query). Online directory services such as AT&T's AnyWho directory service currently provide no information regarding the accuracy of each listing. Because a sizeable fraction of households move every year, a significant number of listings become out-of-date and inaccurate. While it may not be possible to maintain accurate information on all listings, customers would benefit from knowing when the listing was created/updated. A user might, for example, know that the target person they are trying to locate has moved within the past year. By indicating in the search results that the listing is more than one year old, the user would know that that listing is probably not accurate.

In this embodiment, a data field 612 is added to each listing that contains information regarding the accuracy of the listing. That is, the field is populated with information including the last date when the listing was most likely known to be accurate. For example, if the source of the data in the database is from a telephone directory, the accuracy date would be the date on which the information was obtained by the telephone directory publisher or last verified by the telephone directory publisher. The data can be verified by actually calling the telephone number to verify the recipient, by receiving payment of a bill from the listed subscriber of the telephone number from the indicated address, or some other means reasonably inferring that the data is correct. If the data is obtained directly from the telephone service provider's computer systems, the accuracy date would be the date on which the listing or the update was acquired from the computer system. This is because it may generally be assumed that each telephone service provider always has correct information for their subscribers. If data is obtained by the person whose listing it is, the accuracy date would be the date on which that person made the update.

In addition, the database also accepts accuracy information from customers trying to reach the listed person. For example, customers can directly call the listed person from the ANYWHO directory using NET2PHONE or other similar service. After such an attempt is made, customers may be asked if the number they reached was the right one. This information is then used to update the accuracy indicator with the last successful attempt date. It is also possible to maintain a record of the last unsuccessful attempt date (not shown).

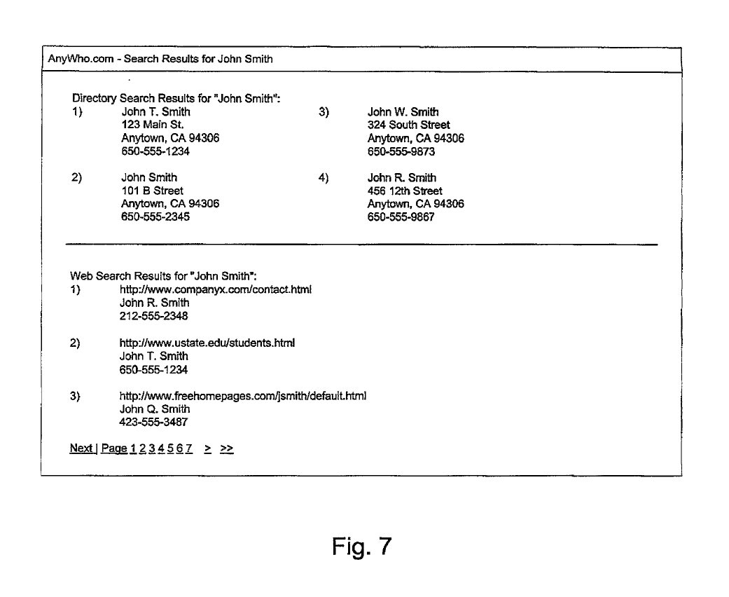

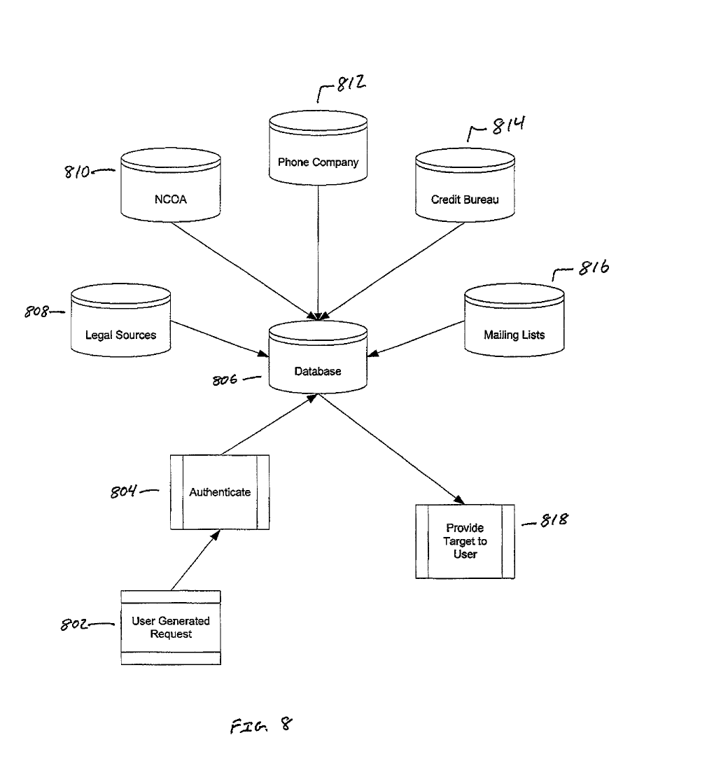

In a fourth embodiment, as shown in FIG. 7, online directory information is supplemented by performing a search for the user-entered information on the world wide web (WWW). In some variations, the WWW search is performed when the user is performing a reverse lookup using either a phone number or email address. A reverse lookup is a search in which the user enters a phone number in order to determine the phone number's listed subscriber's contact information (e.g., name and address). FIG. 7 depicts WWW search results from a conventional directory search (i.e. a name is entered as input, and a telephone number is sought).

When a user wants to do a reverse look up on a phone number, current online directories only query their own databases for this phone number, and return an entry only if there is a match in that database. If there is no match, no information is returned. The present embodiment extends the search to the WWW. Because there is a chance that the provided phone number appears on the WWW in a web page (especially if for a business), the system searches the web for the user-entered phone number, retrieves the web pages that contain the phone number, and provide this information to the user (either in the raw form or after some additional processing, e.g., provide only the header information, look for name information in the page, etc.).

In addition, because current web searches are text based, they only look for exact matches of the text string to be searched for and return web pages that contain that specific string. The provided information (in this case the telephone number), however, may appear in a variety of ways on separate web pages. Thus, at least some of the web pages containing the provided information will not be found or displayed. Telephone numbers can be displayed in various formats, such as: 1) (XXX) YYY-ZZZZ; 2) XXX-YYY-ZZZ; 3) XXX.YYY.ZZZ; or 4) XXX YYY ZZZZ, where XXX is the area code, YYY is the exchange, ZZZZ is the extension, and together, YYY-ZZZZ is the directory number. Other formats are also possible. Thus, when a search of the WWW for a telephone number is performed in the traditional way, relevant web pages are not found due to variations in telephone number formats.

Because it is known that the provided input is a telephone phone number, the present invention uses this knowledge to better search the web by searching for all possible variations of telephone number formats. It is also possible to break the phone number into the area code, exchange, and extension strings, and perform a Boolean search for the phone number using these component strings. Keywords, such as telephone, the abbreviation tel., etc., which normally precede a telephone number, may also be used in the search to identify telephone numbers. If a match is found during the WWW search, this information is provided to the user in addition to the database query results, as shown in FIG. 7.

A similar technique is used for e-mail addresses and other inputs in the query. For instance, if a user is looking for johnsmith@xyz.com, a search of the WWW and newsgroups is performed using the specified address and its variations as input. That is, the search looks for email addresses that at least contain the username, top-level domain name (TLD), and second-level domain name entered by the user. That is, while there may not be any pages with johnsmith@xyz.com, there may be pages with the address johnsmith@abc.xyz.com that would be returned by the WWW search. In such a case, this information is provided to the user.

In some variations, the found web pages are presented to the user to determine whether the identified phone number or email address belongs to the correct individual because the fact that the individual's name and either the input telephone number or email address appear in the same web page does not necessarily infer that they correspond.

In another embodiment of the invention, two or more of the above embodiments are combined to provide more accurate directory listing searches. As is shown in FIG. 6, accuracy information and history/recency information are provided simultaneously to a user, allowing the user to refine and/or narrow the search based on either accuracy information or history/recency information. Also shown in FIG. 6, the search is further refinable based on the inclusion of genealogical information. Other combinations (not shown) are also possible. In some variations, there is an initial interface screen on a display device (not shown) through which a user may select the database(s) through which they would like to try to find a target's directory listing, including a genealogical database, a history database, an accuracy database, and the WWW.

With reference to FIG. 8, multiple resources are used in the various embodiments. A user request 802 is provided. The user request is authenticated and creates a query 804. The query is performed on the combined database 806. The combined database includes information from a plurality of sources, including but not limited to, legal sources 808, National Change Of Address database 810, telephone company databases 812, credit bureau databases 814, and mailing list databases 816. The results 818 of the query are provided to the user.

Having described preferred embodiments (which are intended to be illustrative and not limiting), it is noted that modifications and variations can be made by persons skilled in the art in light of the above teachings. It is therefore to be understood that changes may be made in the particular embodiments of the invention disclosed that are within the scope and spirit of the invention as defined by the appended claims.

Having thus described the invention with the details and particularity required by the patent laws, what is claimed and desired protected by Letters Patent is set forth in the appended claims.

What is claimed is:

1. A method for providing a directory listing, comprising steps of:
receiving query information from a user, wherein said query information includes at least genealogical information corresponding to a user-sought entity.
searching a database for the query information, the database including a plurality of records, each record containing directory listing information for an entity; and
presenting a query result to the user.

2. The method of claim 1, wherein the user-sought entity is an individual.

3. The method of claim 1, wherein the step of receiving the query information from the user is performed via a voice telephone call.

4. The method of claim 1 wherein the database is a central database.

5. The method of claim 1 wherein the database is a distributed database.

6. The method of claim 1 wherein the directory listing includes a telephone number.

7. The method of claim 1 wherein the genealogical information includes one of a parent's name and a sibling's name.

8. The method of claim 1 wherein the receiving and presenting steps are performed over one of a telecommunications network and a computer network.

9. A method for providing a directory listing, the method comprising steps of:
receiving query information from a user;
searching a database for a directory listing corresponding to the query information, wherein the database includes a plurality of records, each record containing directory listing information for an entity;
presenting a query result to the user;
requesting genealogical information corresponding to the query information;
receiving the genealogical information from the user;
searching the database for a directory listing corresponding to the genealogical information; and
presenting a genealogical query result to the user.

10. The method of claim 9, wherein the user-sought entity is an individual.

11. The method of claim 9, wherein the step of receiving the query information from the user is performed via a voice telephone call.

12. The method of claim 9 wherein the database is a central database.

13. The method of claim 9 wherein the database is a distributed database.

14. The method of claim 9 wherein the directory listing includes a telephone number.

15. The method of claim 9 wherein the genealogical information includes at least a parent's name or a sibling's name.

16. The method of claim 9 wherein the receiving and presenting steps are performed over one of a telecommunications network and a computer network.

17. A method for providing a directory listing, comprising the steps:
linking a first record in a database to a second record in the database when the first and second records contain chronologically different information corresponding to a same entity;
receiving from a user, query information corresponding to a user-sought entity;
searching the database for listings corresponding to the query information, wherein said database includes a plurality of records, each record containing directly listing information for an entity;
presenting a query result to the user, wherein said query result includes at least one indicator for each listing that is linked to other listings in the database.

18. The method of claim 17, further comprising the step:
repeatedly presenting linked listings to the user when the user activates the indictor, wherein the linked listings are presented with at least one indicator when the linked listing is linked to other listings in the database.

19. The method of claim 17, wherein a first indicator is presented when the listing is linked to a chronologically older listing in the database, and a second indicator is presented when the listing is linked to a chronologically newer listing in the database.

20. The method of claim 17, wherein the user-sought entity is an individual.

21. The method of claim 17, wherein the step of receiving the query information from the user is performed via a voice telephone call.

22. The method of claim 17 wherein the database is a central database.

23. The method of claim 17 wherein the database is a distributed database.

24. The method of claim 17 wherein the directory listing includes a telephone number.

25. The method of claim 17, wherein the receiving and presenting steps are performed over one of a telecommunications network and a computer network.

26. A method for providing a directory listing, comprising the steps:
receiving from a user, query information corresponding to a user-sought entity;
searching a database for database listings corresponding to the query information, wherein said database includes a plurality of records, each record containing directory listing information and an accuracy data field corresponding to an entity; and
presenting a query result to the user, wherein said query result includes the contents of the accuracy field for each directory listing presented.

27. The method of claim 26, wherein the accuracy data field is a date corresponding to a last date on which the directory listing information was most likely known to be accurate.

28. The method of claim 26, wherein the accuracy data field is a date corresponding to a last date on which the directory listing information was verified to be accurate.

29. The method of claim 26, wherein the accuracy data field is a number corresponding to a number of days since the directory listing information was most likely known to be accurate.

30. The method of claim 26, wherein the accuracy data field is a number corresponding to a number of days since the directory listing information was verified to be accurate.

31. The method of claim 26, wherein the accuracy data field is a percentage corresponding to a likelihood that the directory listing information is accurate.

32. The method of claim 26, wherein the user-sought entity is an individual.

33. The method of claim 26, wherein the step of receiving the query information from the user is performed via a voice telephone call.

34. The method of claim 26 wherein the database is a central database.

35. The method of claim 26 wherein the database is a distributed database.

36. The method of claim 26 wherein the directory listing includes a telephone number.

37. The method of claim 26 wherein the receiving and presenting steps are performed over one of a telecommunications network and a computer network.

38. A method of providing a directory listing, comprising the steps:
receiving query information from a user, wherein said query information includes one of a telephone number and an email address.
searching a database for the query information, the database including a plurality of records, each record containing directory listing information for an entity;
searching the Internet for the query information; and
presenting a query result to the user including results from the database search and the Internet search.

39. The method of claim 38, further comprising the step:
defining an area code portion, an exchange portion, and a number portion corresponding to the telephone number, when the query information includes the telephone number;
wherein the searching the Internet is performed by searching for telephone numbers on web pages, said telephone numbers on web pages including one or more of the area code portion, the exchange portion, and the number portion, regardless of a presentation format on the web pages.

40. The method of claim 38, further comprising the step:
defining a username portion and a domain name portion corresponding to the email address, when the query information includes the email address;
wherein the searching the Internet is performed by searching for email addresses on web pages, said email addresses on web pages including at least the username portion and the domain name portion.

41. The method of claim 38, wherein the user-sought entity is an individual.

42. The method of claim 38, wherein the step of receiving the query information from the user is performed via a voice telephone call.

43. The method of claim 38 wherein the database is a central database.

44. The method of claim 38 wherein the database is a distributed database.

45. The method of claim 38 wherein the directory listing includes a telephone number.

46. The method of claim 38 wherein the receiving and presenting steps are performed over one of a telecommunications network and a computer network.

47. A system for providing a directory listing, comprising:
a database including a plurality of records, each record containing directory listing information for an entity;
a server computer adapted to perform the steps:
receiving query information from a user, wherein said query information includes at least genealogical information corresponding to a user-sought entity.
searching the database for the query information; and
presenting a query result to the user.

48. The system of claim 47, wherein the user-sought entity is an individual.

49. The system of claim 47, wherein the step of receiving the query information from the user is performed via a voice telephone call.

50. The system of claim 47 wherein the database is a central database.

51. The system of claim 47 wherein the database is a distributed database.

52. The system of claim 47 wherein the directory listing includes a telephone number.

53. The system of claim 47 wherein the genealogical information includes at least one of a parent's name and a sibling's name.

54. The system of claim 47 wherein the receiving and presenting steps are performed over one of a telecommunications network and a computer network.

55. A system for providing a directory listing, comprising:
a database comprising a plurality of records, each record containing directory listing information for an entity;
a server computer adapted to perform the steps:
receiving query information from a user;
searching the database for a directory listing corresponding to the query information;
presenting a query result to the user;
requesting genealogical information corresponding to the query information;
receiving the genealogical information from the user;
searching the database for a directory listing corresponding to the genealogical information; and
presenting a genealogical query result to the user.

56. The system of claim 55, wherein the user-sought entity is an individual.

57. The system of claim 55, wherein the step of receiving the query information from the user is performed via a voice telephone call.

58. The system of claim 55 wherein the database is a central database.

59. The system of claim 55 wherein the database is a distributed database.

60. The system of claim 55 wherein the directory listing includes a telephone number.

61. The system of claim 55 wherein the genealogical information includes at least a parent's name or a sibling's name.

62. The system of claim 55 wherein the receiving and presenting steps are performed over one of a telecommunications network and a computer network.

63. A system for providing a directory listing, comprising:
a database comprising a plurality of records, each record containing directory listing information for an entity, wherein a first record in the database is linked to a second record in the database when the first and second records contain chronologically different information corresponding to a same entity;
a server computer adapted to perform the steps:
receiving from a user, query information corresponding to a user-sought entity;
searching the database for listings corresponding to the query information;
presenting a query result to the user, wherein said query result includes at least one indicator for each listing that is linked to other listings in the database.

64. The system of claim 63, wherein the server computer is adapted to recursively present a linked listing to the user when the user activates the indictor, wherein the linked listing is presented with at least one indicator when the linked listing is linked to at least one other listing in the database.

65. The system of claim 63, wherein the server computer is adapted to present a first indicator when the listing is linked to a chronologically older listing in the database, and to present a second indicator when the listing is linked to a chronologically newer listing in the database.

66. The system of claim 63, wherein the user-sought entity is an individual.

67. The system of claim 63, wherein the step of receiving the query information from the user is performed via a voice telephone call.

68. The system of claim 63 wherein the database is a central database.

69. The system of claim 63 wherein the database is a distributed database.

70. The system of claim 63 wherein the directory listing includes a telephone number.

71. The system of claim 63, wherein the receiving and presenting steps are performed over one of a telecommunications network and a computer network.

72. A system for providing a directory listing, comprising:
a database comprising a plurality of records, each record containing directory listing information and an accuracy data field corresponding to an entity;
a server computer adapted to perform the steps:
receiving from a user, query information corresponding to a user-sought entity;
searching the database for database listings corresponding to the query information;
presenting a query result to the user, wherein said query result includes the contents of the accuracy field for each directory listing presented.

73. The system of claim 72, wherein the accuracy data field is a date corresponding to a last date on which the directory listing information was most likely known to be accurate.

74. The system of claim 72, wherein the accuracy data field is a date corresponding to a last date on which the directory listing information was verified to be accurate.

75. The system of claim 72, wherein the accuracy data field is a number corresponding to a number of days since the directory listing information was most likely known to be accurate.

76. The system of claim 72, wherein the accuracy data field is a number corresponding to a number of days since the directory listing information was verified to be accurate.

77. The system of claim 72, wherein the accuracy data field is a percentage corresponding to a likelihood that the directory listing information is accurate.

78. The system of claim 72, wherein the user-sought entity is an individual.

79. The system of claim 72, wherein the step of receiving the query information from the user is performed via a voice telephone call.

80. The system of claim 72 wherein the database is a central database.

81. The system of claim 72 wherein the database is a distributed database.

82. The system of claim 72 wherein the directory listing includes a telephone number.

83. The system of claim 72 wherein the receiving and presenting steps are performed over one of a telecommunications network and a computer network.

84. A system for providing a directory listing, comprising:
a database comprising a plurality of records, each record containing directory listing information for an entity;
a server computer adapted to perform the steps:
receiving query information from a user, wherein said query information includes one of a telephone number and an email address.
searching the database for the query information;
searching the Internet for the query information; and
presenting a query result to the user including results from the database search and the Internet search.

85. The system of claim 84, wherein the server computer is adapted to perform the step:
defining an area code portion, an exchange portion, and a number portion corresponding to the telephone number, when the query information includes the telephone number;
wherein the searching the Internet is performed by searching for telephone numbers on web pages, said telephone numbers on web pages including one or more of the area code portion, the exchange portion, and the number portion, regardless of a presentation format on the web pages.

86. The system of claim 84, wherein the server computer is adapted to perform the step:
defining a username portion and a domain name portion corresponding to the email address, when the query information includes the email address;
wherein the searching the Internet is performed by searching for email addresses on web pages, said email addresses on web pages including at least the username portion and the domain name portion.

87. The system of claim 84, wherein the user-sought entity is an individual.

88. The system of claim 84, wherein the step of receiving the query information from the user is performed via a voice telephone call.

89. The system of claim 84 wherein the database is a central database.

90. The system of claim 84 wherein the database is a distributed database.

91. The system of claim 84 wherein the directory listing includes a telephone number.

92. The system of claim 84 wherein the receiving and presenting steps are performed over one of a telecommunications network and a computer network.

93. A method for providing a directory listing, comprising steps of:
(1) presenting to a user a plurality of choices;
(2) waiting for the user to select at least one of said choices; and
(3) performing a search for a directory listing in accordance with the user selection.

94. The method of claim 93, wherein the choices comprise various databases in which to perform the search.

95. The method of claim 94, wherein the various databases comprise genealogical information, historical information, accuracy information, and world wide web information.

96. A computer system for providing a directory listing, comprising:
a processor;
a memory for storing computer readable instructions;
wherein when the computer readable instructions are executed, the computer system is adapted to perform the steps:
presenting to a user a plurality of choices;
waiting for the user to select at least one of said choices; and
performing a search for a directory listing in accordance with the user selection.

97. The method of claim 96, wherein the choices comprise various databases in which to perform the search.

98. The method of claim 97, wherein the various databases comprise genealogical information, historical information, accuracy information, and world wide web information.
